(19) United States
(12) Patent Application Publication
(10) Pub. No.: US 2006/0109579 A1
(43) Pub. Date: May 25, 2006

(54) Magnetic recording medium, magnetic record reproducing apparatus, and method of reproducing data

(75) Inventors: Makoto Asakura, Tokyo (JP); Masatoshi Sakurai, Tokyo (JP); Yuji Sakai, Tokyo (JP)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: Kabushiki Kaisha Toshiba, Minato-ku (JP)

(21) Appl. No.: 11/285,251

(22) Filed: Nov. 22, 2005

(30) Foreign Application Priority Data
Nov. 24, 2004 (JP) 2004-339685

(51) Int. Cl. G11B 5/09

(52) U.S. Cl. 360/49; 360/48

(57) ABSTRACT

A magnetic recording medium includes a data area in which data can be written and a servo area in which information is recorded for positioning a magnetic head to a target position. The servo area has a preamble area for clock synchronization and an address area where address information of sectors and cylinders is recorded, and a ratio of a magnetic portion to a non-magnetic portion in a total of the data area, the preamble area, and the address area is substantially 2:1.

### CROSS-REFERENCE TO RELATED APPLICATIONS

This application is based upon and claims the benefit of priority from the prior Japanese Patent Application No. 2004-339685, filed on Nov. 24, 2004; the entire contents of which are incorporated herein by reference.

### BACKGROUND OF THE INVENTION

1. Field of the Invention

The present invention relates to a magnetic recording medium having a servo area where information for positioning a magnetic head at a target position is recorded, a magnetic record reproducing apparatus for reproducing information from the magnetic recording medium, and a method of reproducing data.

2. Description of the Related Art

A magnetic recording medium such as a hard disk (HD) has a data area where data can be written into, and a servo area where servo information for positioning of a magnetic head at a desired track or a desired sector is recorded.

Conventionally, the servo information is recorded with the use of a servo track writer (STW) after a manufacture of the magnetic recording medium is finished. However, an increasing recording density of the magnetic recording medium renders the process of servo information recording with the STW increasing time-consuming, deteriorating the productivity of the magnetic recording medium.

In addition, when a conventionally known patterned media, in which a data area is previously formed as a track, is manufactured, the servo information must be recorded into an area other than the previously formed track of the data area. Hence, if the servo information is to be recorded with the STW, the STW must be positioned at such area prior to the recording of the servo information, which positioning process is extremely difficult to realize.

To overcome such inconvenience, Japanese Patent Application Laid-Open No. 62-256225, for example, discloses a technique for recording the servo information in advance as an embedded pattern of an uneven magnetic layer on the patterned media. A proposed example of the patterned media where such technique is utilized is, for example, a discrete track media in which tracks are formed as magnetic bodies physically separated from each other in a track width direction.

In the patterned media where the servo data is recorded as an embedded pattern, a ratio of a magnetic portion to a non-magnetic portion in a formed mark has a significant influence on the stability of an imprinting.

The ratio of magnetic portions in the data area widely varies according to the type of the employed patterned media. In the magnetic recording medium in which isolated particles are formed, the ratio of magnetic portions in the data area is approximately 35%, whereas in the magnetic recording medium of a discrete track type, the ratio of magnetic portions in the data area is approximately 70%.

On the other hand, in the servo area, which is formed from a preamble area, an address area, and a burst area, information is recorded according to Manchester coding to maximize the signal to noise (S/N) ratio at signal reproduction. According to the Manchester coding, a binary value “0” is recorded as “0,1”, and a binary value “1” is recorded as “1,0”. Hence, in the servo area other than the burst area, the ratio of magnetic portions is approximately 50%. In the burst area, the ratio of magnetic portions is approximately 25%.

When the ratio of magnetic portions formed as an uneven pattern largely differs between the data area and the servo area, stress distribution at the imprinting also differs in the manufacture of the magnetic recording medium, thereby a stable imprinting of magnetic pattern is hampered. For the realization of the stable imprinting, the difference in the ratios of magnetic portions in the data area and the servo area needs to be minimized.

Above-described inconvenience might be alleviated and the reproduction of the servo data might be performed without problem if the ratio of the magnetic portion to the non-magnetic portion in the servo area is reversed to adjust the ratio of the magnetic portions, and data reproduction is performed with an inverted version of a reproduction signal from the servo area. In the conventional magnetic recording medium, however, since the servo data in the servo area is recorded according to the Manchester coding, the inversion of the ratio of the magnetic portions to the non-magnetic portions in the servo area does not affect the ratio of magnetic portions, which remains to be 50%, and the ratio of the magnetic portions cannot be adjusted through such technique.

In the magnetic recording medium, the data area occupies a large area of the medium. For example, in the magnetic recording medium of the discrete track type, the ratio of magnetic portions on the entire medium is expected to be approximately 65 to 75%, and in the patterned media in a narrower sense, i.e., in which isolated particles are recorded, the ratio of the magnetic portions on the entire medium is expected to be approximately 30 to 40%. In view of the ratio of the magnetic portions in the data area of the magnetic recording medium, the area occupied by the servo area is preferably 65 to 75% in the discrete track type magnetic recording medium, and 30 to 35% in the patterned media in a narrower sense in which isolated particles are formed.

### SUMMARY OF THE INVENTION

According to one aspect of the present invention, a magnetic recording medium includes a data area into which data can be written; and a servo area having a preamble area that serves to realize clock synchronization and an address area in which address information of sectors and cylinders is recorded, and a ratio of a magnetic portion to a non-magnetic portion in a total of the data area, the preamble area, and the address area is substantially 2:1.

According to another aspect of the present invention, a magnetic record reproducing apparatus includes an address area reproducing unit which reproduces data from an address area of a magnetic recording medium. The magnetic recording medium includes a data area to which data can be written into and a servo area where information for positioning a magnetic head at a target position is recorded. The servo area has a preamble area that serves to realize clock synchronization and the address area in which address information of a sector and a cylinder is recorded. The address information is recorded as a three-digit ternary value represented by “1” and “0”, wherein when a magnetic portion and a non-magnetic portion are represented as “1” and “0”, respectively. A ratio of a portion where “1” is recorded to a portion where “0” is recorded is 2:1. The address area reproducing unit includes a ternary code converter that finds the three-digit ternary value corresponding to a sampled value from one cycle of an address reproduction signal reproduced from the address area. The sampled value is sampled with a synchronization clock determined according to a reproduction signal processing for the preamble area. The address area reproducing unit also includes a ternary value reproducing unit that converts the ternary value obtained by the ternary code converter into the address information represented by a binary value.

According to still another aspect of the present invention, a method of reproducing data includes reproducing data from an address area of a magnetic recording medium. The magnetic recording medium includes a data area to which data can be written into and a servo area where information for positioning a magnetic head at a target position is recorded. The servo area has a preamble area that serves to realize clock synchronization and the address area in which address information of sectors and cylinders is recorded. The address information is recorded as a three-digit ternary value represented by “1” and “0”, wherein when a magnetic portion and a non-magnetic portion are represented as “1” and “0”, respectively. A ratio of a portion where “1” is recorded to a portion where “0” is recorded is 2:1. The reproducing includes finding the three-digit ternary value corresponding to a sampled value from one cycle of an address reproduction signal reproduced from the address area. The sampled value is sampled with a synchronization clock determined according to a reproduction signal processing for the preamble area. The reproducing also includes converting the ternary value found into the address information represented by a binary value.

### BRIEF DESCRIPTION OF THE DRAWINGS

FIG. 1 is a schematic diagram of a structure of tracks of a magnetic recording medium according to an embodiment of the present invention;

FIG. 2 is a table of an example of a ternary gray code;

FIG. 3 is a table of a correspondence of a cylinder address “52001” (decimal), a previous address and a following address thereof, ternary gray codes obtained via a conversion thereof, and binary gray codes recorded in an address area of a conventional magnetic recording medium;

FIG. 4 is a block diagram of a structure of an address area reproducing circuit according to the embodiment of the present invention;

FIG. 5 is a graph illustrating a six-point sampling from one cycle of an address reproduction signal corresponding to a recorded code “110”;

FIGS. 6A to 6D are graphs illustrating an influence on sampled values of the address reproduction signal corresponding to the recorded code “110” exerted by cells before and after a cell of the address reproduction signal;

FIG. 7 is a flowchart of a process sequence of reproduction from the address area by the address area reproducing circuit; and

FIG. 8 is a block diagram of a structure of the address area reproducing circuit that performs determination on a recorded code via maximum likelihood estimation using a ternary Viterbi decoder.

### DETAILED DESCRIPTION OF THE PREFERRED EMBODIMENTS

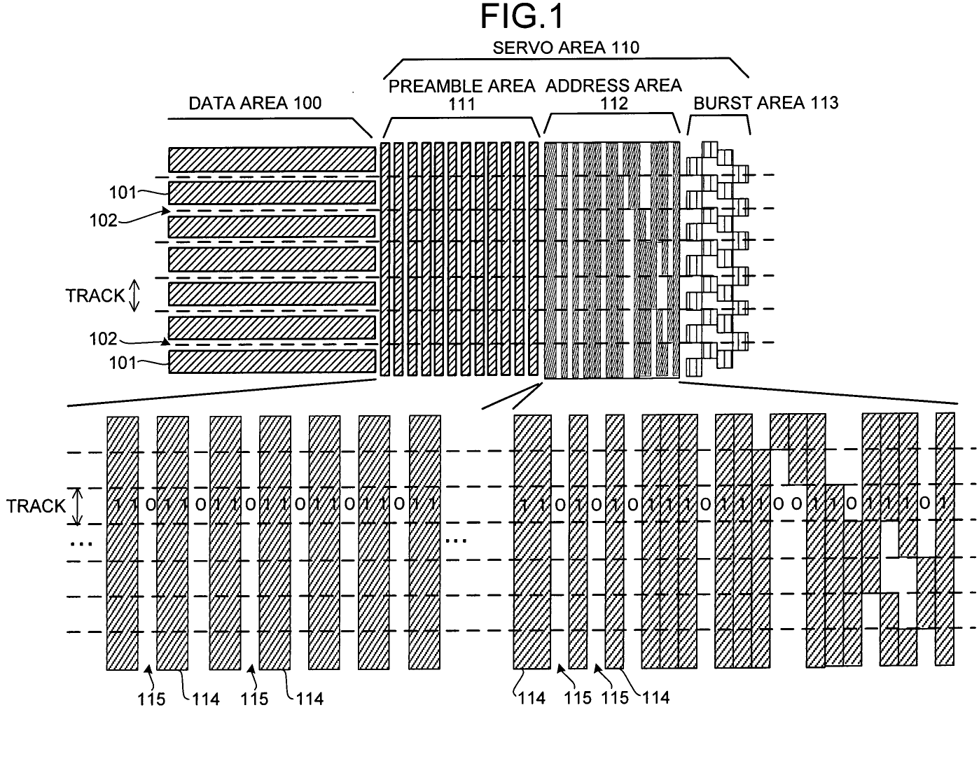

FIG. 1 is a schematic diagram of a structure of tracks of a magnetic recording medium according to an embodiment. In FIG. 1, a track structure is shown in an upper half portion and a detailed structure of an address area is shown in a lower half portion. The track of the magnetic recording medium according to the embodiment includes, as shown in FIG. 1, a data area 100 and a servo area 110.

The data area is an area to which user data can be written and from which user data can be read out. The data area 100 is formed, as shown in FIG. 1, with plural tracks having respective magnetic bands 101 in which data can be written, and non-magnetic bands 102 which are arranged between the adjacent tracks and in which data cannot be written. The magnetic recording medium of the embodiment is a recording medium of a discrete track type in which the magnetic bands are physically separated from each other by the non-magnetic bands. The ratio of the magnetic bands 101 to the non-magnetic bands 102 in the data area 100 is 5:2, and the ratio of the magnetic portions in the data area 100 is approximately 71.4%.

The servo area 110 is an area where the servo data is recorded for positioning of a magnetic head of a magnetic record reproducing apparatus at a target position. In the servo area 110, a magnetic portion is formed in which a magnetic mark serves as servo data is provided. The servo data is formed through imprinting by a stamper during the manufacture of the magnetic recording medium. The formation of the servo data is not limited to the imprinting as in the embodiment, and may be realized through recording by the STW.

The magnetic recording medium according to the embodiment adopts a perpendicular magnetic recording according to which magnetic films in the magnetic portions and the magnetic bands are magnetized in a perpendicular direction (direction of a medium thickness). In addition, the magnetic recording medium according to the embodiment is structured so that a non-magnetic body fills the non-magnetic portions and the non-magnetic bands. It should be noted that the structure of the non-magnetic portions and non-magnetic bands is not limited to the structure according to the embodiment, and the non-magnetic portions and the non-magnetic bands may be formed as air gaps.

The servo area 110 is formed, as shown in FIG. 1, from a preamble area 111, an address area 112, and a burst area 113.

The preamble area 111 is an area where a preamble signal for clock synchronization is recorded. Data in the preamble area 111 is read out by the magnetic head prior to the data reading from the address area 112 and the burst area 113 at the positioning control of the magnetic head, and employed for processing such as Phase Lock Loop (PLL) for synchronization of a clock for servo signal reproduction to compensate for a time lag caused by deviation in a rotational axis of the magnetic recording medium, and auto gain control (AGC) for appropriate maintenance of an amplitude of signal reproduction.

In FIG. 1, “1” indicates a magnetic portion 114, whereas “0” indicates a non-magnetic portion 115. As shown in FIG. 1, in the preamble area 111 of the magnetic recording medium according to the embodiment, a preamble signal is recorded as a magnetic pattern having one cycle represented by “110”. The ratio of the magnetic portions 114 to the non-magnetic portions 115 in the preamble area 111 is, therefore, 2:1, and the ratio of an area occupied by the magnetic portions in the preamble area 111 is approximately 66.7%.

The burst area 113 is an area where a magnetic pattern is recorded as to allow for derivation of information on positional deviation that indicates a relative position of the magnetic head with respect to the center of the track. The burst area 113 of the magnetic recording medium according to the embodiment is similarly structured as the conventional magnetic recording medium and the ratio of the area occupied by the magnetic portions in the burst area 113 is approximately 25%.

The address area 112 is an area where a code which is called a “servo mark,” sector information, cylinder information, or the like are recorded.

In the magnetic recording medium according to the embodiment, address information to be recorded in the address area is converted into a ternary value, and a ternary value “0” corresponds to “011”, a ternary value “1” corresponds to “101”, and a ternary value “2” corresponds to “110”. Thus, each ternary value is made corresponding to a three-digit representation consisting of two “1” and one “0” and recorded as such. Here, “1” indicates the magnetic portion 114, whereas “0” indicates the non-magnetic portion 115.

In the conventional magnetic recording medium, address information in the address area is recorded according to the Manchester coding. According to the Manchester coding, address information is first converted into a binary value, and bits “0” and “1” of the binary value are recorded as “01” and “10”, respectively. Thus, in the reproduction signals in the address area, every converted bit transits, i.e., binary value “0” (“01” in Manchester coding) of the converted bit of the address information transits to “1” and binary value “1” (“10” in Manchester coding) of the converted bit of the address information transits to “0”, for the improvement in the S/N ratio of the reproduction signal.

In addition, to minimize erroneous detection caused by a skew running of the magnetic head during seek, i.e., during an inter-track movement of the magnetic head, at least cylinder information (servo track address information) is recorded in a gray code, according to which bit transition in binary values of adjacent cylinders occurs only at one point. Thus, erroneous detection is prevented.

In the magnetic recording medium with the structure of the magnetic portions and the non-magnetic portions as described above, however, a rate of unevenness of a stamper to be employed for the imprinting of the magnetic pattern during the manufacture of the magnetic recording medium is different from area to area. Then, if changes in distribution of the rate of unevenness of the stamper are significant, the imprinting might not be realized uniformly. Then, a stable imprinting of the magnetic pattern on an entire surface of the magnetic recording medium is difficult to realize.

Hence, in the address area of the magnetic recording medium according to the embodiment, the address information is converted into ternary values, and the ternary value “0”, “1”, and “2” are made to correspond with recorded codes “011”, “101”, “110”, respectively, for recording. Thus, the rate of unevenness of the stamper is substantially made uniform on the entire surface thereof, whereby a stable imprinting of the magnetic recording medium is allowed. Here, each of the recorded codes “011”, “101”, and “110” corresponding to one digit of the ternary value constitutes one cycle of the reproduction signal.

In the address area of the magnetic recording medium according to the embodiment, sector information of the address information is converted into a ternary value and each digit of the ternary value is recorded corresponding to the recorded codes described above. For example, address information of sector number 21 is represented as “00210” when converted into five-digit ternary value, and hence, the recorded code corresponding thereto is of a minimum length, i.e., 15 cells, such as “011 011 110 101 011”. In the conventional magnetic recording medium, the address information of the sector number 21 is represented as “00010101” when converted into an 8-bit binary value, and hence, recorded in a 16 cell length, such as “01 01 01 10 01 10 01 10” according to the Manchester coding.

Here, a switching frequency of the recorded code is designed according to a similar manner as the conventional technique, so that decrease in the number of digits due to the conversion into the ternary value is offset by increase in the pattern length of the three-cell code. Thus, the address area length is substantially the same as the address area length of the conventional magnetic recording medium. In the embodiment, the recorded code of the ternary value is 15 cells in sector length and 33 cells in cylinder length, resulting in total length of 48 cells. On the other hand, in the recorded code of the binary value as in the conventional magnetic recording medium, sector length is 16 cells, and cylinder length is 32 cells, resulting in the total of 48 cells, which is same with the length in the embodiment.

In the recorded code of the ternary value, the transition always occurs as described above from “0” to “1” or from “1” to “0”. In other words, in the ternary value “0” (“011” in recorded code) the increase of the signal from “0” to “1”, in the ternary value “1” (“101” in recorded code) the decrease of the signal from “1” to “0” and the increase from “0” to “1”, and in the ternary value “2” (“110” in recorded code) the decrease of the signal from “1” to “0” occurs to clearly show the signal change in one digit of the ternary value. Thus, the signal reproduction is readily realized without the decrease in the S/N ratio of the reproduction signal in the address area.

In the embodiment, the ternary values “0”, “1”, and “2” are made to correspond with the recorded codes “011”, “101”, and “110”, respectively, so that the ratio of the magnetic portion 114 to the non-magnetic portion 115 is 2:1, though the embodiment is not a limiting example. Alternatively, the correspondence with the ternary values can be realized so that one digit of the ternary value includes one “0” and two “1” as to make the ratio of the magnetic portion to the non-magnetic portion 2:1.

Further, in the address area of the magnetic recording medium according to the embodiment, cylinder information of the address information is converted into the ternary value and further converted into the ternary gray code (hereinafter simply referred to as “ternary gray code”). Each digit of the converted ternary value is recorded in correspondence with the recorded code described above.

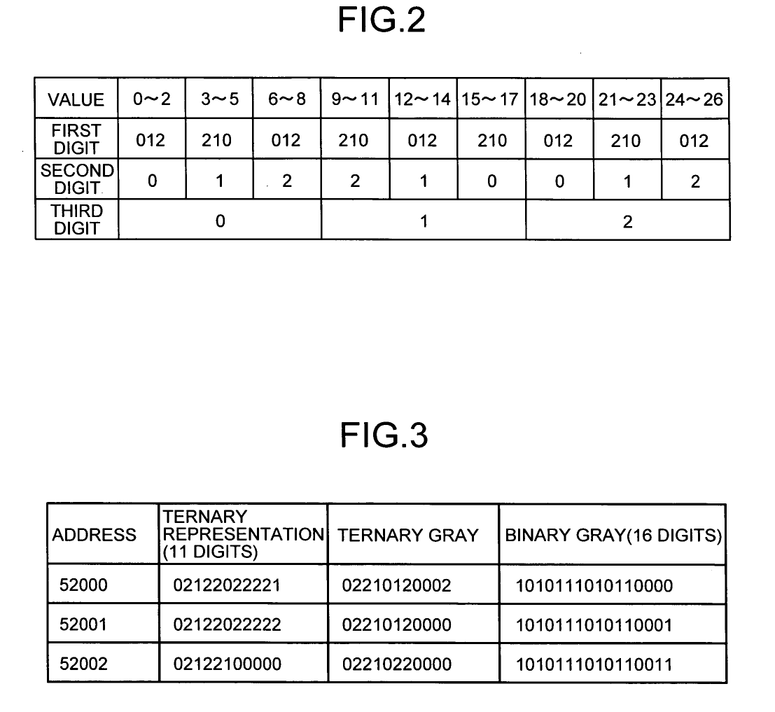

Here, the gray code is a code where a bit change between adjacent data strings occurs only in one bit, and serves to prevent erroneous detection of the address in the adjacent tracks during the seek operation in which the magnetic head is moving between tracks as reading out the address. The gray code is conditioned so that a humming distance between adjacent codewords is always one, and that respective digits in successive codewords repeat a symmetric, numerical pattern. The ternary gray code that satisfies such conditions can be represented as in FIG. 2 in a strict sense.

When the strict ternary gray code as shown in FIG. 2 is employed, however, the conversion of the ternary values of cylinder information to the ternary gray code, and the inversion of the ternary gray code to the ternary values of cylinder information are complicated and little feasible. Simply to prevent the erroneous detection of the address during the seek operation of the magnetic head, satisfaction of merely one condition that the humming distance is always one suffices.

Hence, in the embodiment, the ternary value of the cylinder information is converted into a ternary gray code according to expression (1), and each digit of the converted ternary gray code, i.e., the ternary value “0”, “1”, and “2” are made to correspond with the recorded codes “011”, “101”, and “110”, respectively, for recording into the address area 112:
Gray(k)=mod(2*Tri(k+1)+Tri(k), 3) (1)
where mod(m, n) is a residual function for finding a residue at division of m by n, Gray(k) is a value in the k-th digit of a ternary gray code, and Tri(k) is a value in the k-th digit of an 11-digit ternary value of cylinder address. Thus, the conversion from the ternary value of cylinder information into the ternary gray code and the inversion of the ternary gray code into the ternary value of cylinder information are readily realized.

When the cylinder address is “52001” (decimal), the ternary gray code of the embodiment can be described as follows: ternary value of “52001” (decimal) is “02122022222” (ternary) and Tri(11)=0, Tri(10)=2, and Tri(9)=1, Tri(1)=2. Hence, according to equations (2), the ternary gray code “02210120000” can be found:
Gray(11)=mod(2*0+0, 3)=0
Gray(10)=mod(2*0+2, 3)=2
Gray(9)=mod(2*2+1, 3)=2
Gray(8)=mod(2*1+2, 3)=1
Gray(7)=mod(2*2+2, 3) =0
Gray(6)=mod(2*2+0, 3)=1
Gray(5)=mod(2*0+2, 3)=2
Gray(4)=mod(2*2+2, 3)=0
Gray(3)=mod(2*2+2, 3)=0
Gray(2)=mod(2*2+2, 3)=0
Gray(1)=mod(2*2+2, 3)=0 (2)
Here, in the calculation of Gray(11), Tri(12) is zero.

FIG. 3 is a table of a correspondence of the cylinder address “52001” (decimal) and addresses before and after the cylinder address “52001”, the converted ternary gray codes, and the binary gray codes recorded in the address area of the conventional magnetic recording medium.

As shown in FIG. 3, between the ternary gray code of the address “52000” (decimal) and the ternary gray code of the address “52001” (decimal), only the value in the first digit has changed. Between the address “52001” (decimal) and the address “52002” (decimal), only the value in the sixth digit has changed. Thus, it can be seen that also in the ternary gray code employed in the magnetic recording medium according to the embodiment, the code change position between the adjacent tracks is limited to one position.

Here, four types of ternary gray codes with one humming distance are conceivable including the strict gray code mentioned above. However, the ternary gray code adopted in the embodiment is most efficient in terms of the inversion from the ternary gray code to the ternary value. However, the ternary gray code of the embodiment is not a limiting example, and the ternary value of cylinder information may alternatively be converted into another ternary gray code.

In the magnetic recording medium according to the embodiment, the sector information in the address area 112 of the servo area 110 is converted into the recorded code of ternary value, and the cylinder information is converted into the recorded code of ternary gray code according to equation (1). A stamper having an unevenness corresponding to the recorded codes is fabricated in a mastering process. Through the imprinting process, magnetic body working process, or the like with the stamper, the magnetic recording medium with embedded servo data is manufactured (as a patterned media).

Thus, in the magnetic recording medium according to the embodiment, the ratio of the magnetic portion to the non-magnetic portion is 5:2 in the data area 100, 2:1 in the preamble area 111 and the address area, and approximately 2:1 in the data area 100 and the servo area other than the burst area 113. Thus, the imprinting can be stably realized with the stamper in the manufacture of the magnetic recording medium, whereby the production yield of the magnetic recording medium can be significantly improved.

Next, the magnetic record reproducing apparatus that reproduces data from the magnetic recording medium according to the embodiment will be described. The magnetic head detects leakage magnetic field as an electric signal from the magnetic pattern on the disk right below the magnetic head, and sends the electric signal to a reproduction signal processing integrated circuit (IC) (channel) via a head amplifier IC (HIC). The reproduction signal processing IC serves to perform reproduction process of the signal read out from each of the preamble area 111, the address area 112, and the burst area 113 by the magnetic head. In the description of the embodiment, an address area reproducing circuit that reproduces a signal from the address area 112 will be described.

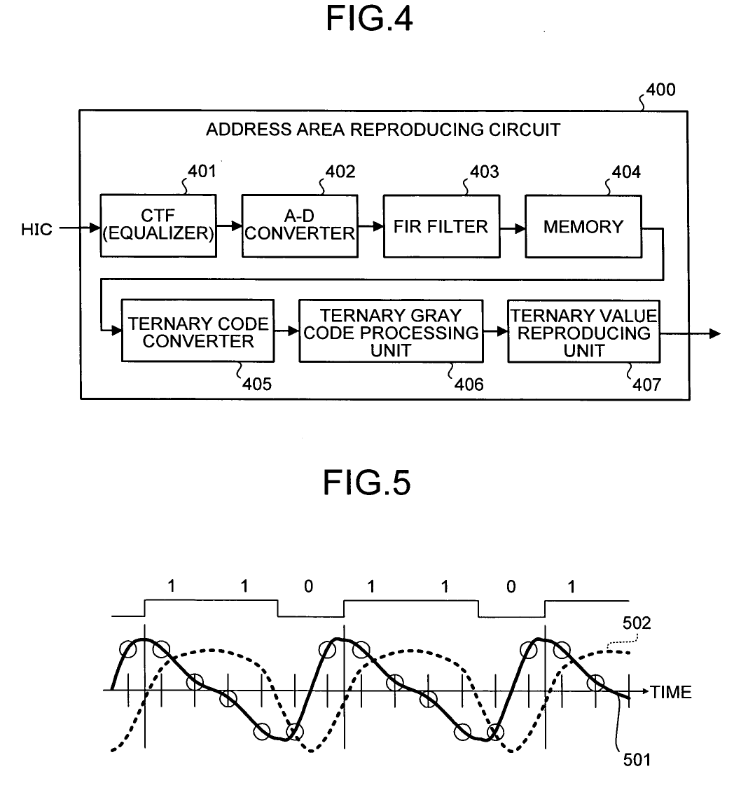

FIG. 4 is a block diagram of a structure of the address area reproducing circuit according to the embodiment. An address area reproducing circuit 400 according to the embodiment is, as shown in FIG. 4, mainly includes a continuous time filter (CTF) 401, an analog-digital (A-D) converter 402, a finite impulse response (FIR) filter 403, a memory 404, a ternary code converter 405, a ternary gray code processing unit 406, and a ternary value reproducing unit 407.

Since the recording in the magnetic portion of the magnetic recording medium of the embodiment is realized according to the perpendicular magnetic recording, the CTF 401 performs analog filtering of an analog reproduction signal reproduced from the address area 112 with a low pass filter (LPF) or the like to convert the same into an equalization signal which corresponds to a longitudinal record reproduction signal.

The A-D converter 402 converts the analog equalization signal obtained by the CTF 401 into a digital value. In the processing of the reproduction signal from the preamble area 111, the synchronization with the cycle of the signal is performed, and the reproduction signal is sampled at six points in each cycle.

The A-D converter 402 converts the analog equalization signal supplied from the CTF 401 into the digital address reproduction signal at a same clock timing with a synchronization clock of the reproduction signal supplied from a phase locked loop (PLL) circuit (not shown). The synchronization clock is determined in a state after the completion of synchronization in a latter part of the reproduction process of the preamble area described above. The sampled value is supplied to the FIR filter 403 as an output. In the embodiment, sampled values are taken at six points from one cycle of the address reproduction signal, i.e., from the recorded codes “011”, “101”, and “110” of three cells each corresponding to one digit of the ternary value, similarly to the reproduction process of the preamble area 111.

FIG. 5 is a graph illustrating a state of six-point sampling from one cycle of the address reproduction signal corresponding to the recorded code “110”, and in the drawing a dotted line indicated by a reference number 502 represents an output signal from the HIC of the address reproduction signal of “110”, whereas a solid line indicated by a reference number 501 represents a waveform equalization signal of the output signal.

The FIR filter 403 is formed from a six-tap filter and further equalizes the sampled values of the address reproduction signal after the conversion into the digital signals by the A-D converter 402, to reduce the noise. The FIR filter 403 stores the equalized six-point sampled values as six-value vectors in the memory 404.

The memory 404 serves to store the equalized versions provided by the FIR filter 402 of the sampled values taken by the A-D converter 402 at six points of one cycle of the address reproduction signal. Thereafter, each processing by the ternary code converter 405, the ternary gray code processing unit 406, and the ternary value reproducing unit 407 is performed for each cycle of the six-point sampled value.

The ternary code converter 405 acquires the six-point sampled values for one cycle of the address reproducing signal from the memory 404 to determine which of the recorded codes “110”, “101”, and “011” the address reproduction signal corresponds, and determines which one of ternary value “0”, “1”, and “2” corresponds to the recorded code, to send the result to the ternary gray code processing unit 406.

More specifically, the ternary code converter 405 determines which recorded code corresponds to the address reproduction signal based on the six-point sampled values as follows.

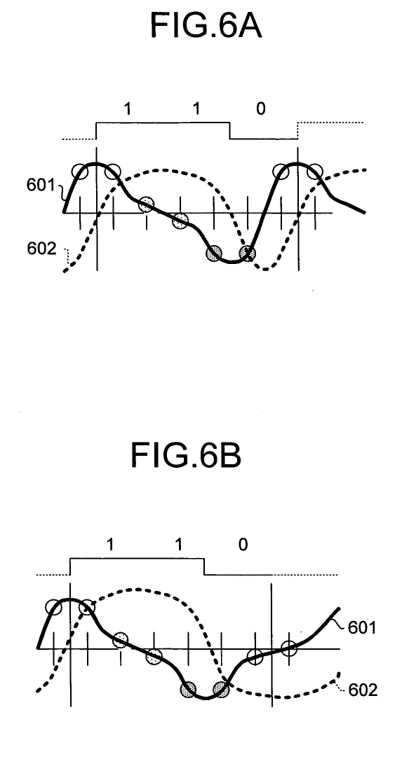

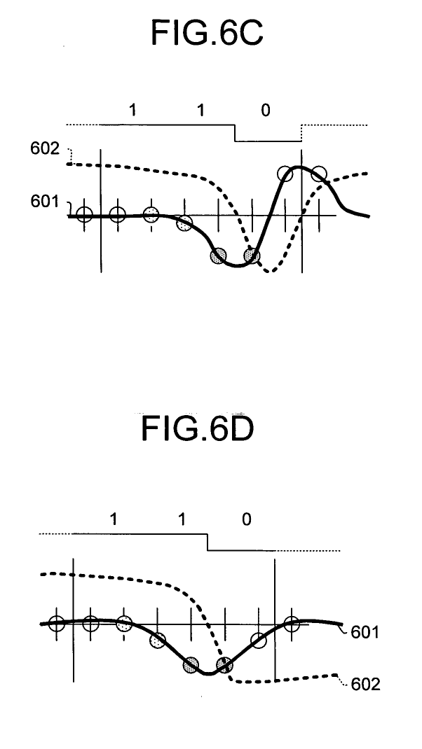

FIGS. 6A to 6D are graphs illustrating the influence on the address reproduction signal of the recorded code “110” by the cells located before and after the cell of the address reproduction signal. Here, a dotted line indicated by a reference number 602 represents the output signal from the HIC of the address reproduction signal “110” and a solid line indicated by a reference number 601 represents the waveform equalization signal of the output signal.

FIG. 6A shows a relation between the address reproduction signal and the sampled value when the previous cell is “0” and the following cell is “1”. FIG. 6B shows a relation between the address reproduction signal and the sampled value when both the previous cell and the following cell are “0”. FIG. 6C shows a relation between the address reproduction signal and the sampled value when both the previous cell and the following cell are “1”. FIG. 6D shows a relation between the address reproduction signal and the sampled value when the previous cell is “1” and the following cell is “0”.

As can be seen from FIGS. 6A to 6D, even when the address reproduction signal is same and is “110”, detected distribution of magnetic field is influenced by the values of the previous and the following cells, and even when the noise is ignored, the address reproduction signal cannot be rendered the same.

As can be seen from FIGS. 6A to 6D, however, the influence by the values of the previous and the following cells most notably appear in the first and the sixth sampled values, and is not very much noticeable in the sampled value taken at around the middle of the cycle. Hence, in the embodiment, the amplitude of the six-point sampled values is normalized to one to obtain a sampled value vector y=[y1, y2, y3, y4, y5, y6], and an inner product factor [0, 1, 1, 1, 1, 0] is set to put higher weights to the sampled values at the center than to the sampled values at the periphery in one cycle of the address reproduction signal, and the inner product is calculated as determination information G as shown in equation (3):
G=[0, 1, 1, 1, 1, 0]*[y1, y2, y3, y4, y5, y6]^{t} (3)

Then, based on a value of the determination information G, it is determined which recorded code corresponds to the address reproduction signal of one cycle. Here, when the six-point sampled value of the recorded code “110” (ternary value “2”) shown in FIG. 5 is normalized to have an amplitude of one, y=[1, 0, 0, −1, −1, 1] is obtained, and G=−2 holds according to equation (3). Further, when the six-point sampled value of the recorded code “101” (ternary value “1”) is normalized to have an amplitude of one, then, y=[0, −1, −1, 1, 1, 0], and G=0 holds according to equation (3). Further, when the six-point sampled value of the recorded code “011” (ternary value “2”) is normalized to have an amplitude of one, then, y=[−1, 1, 1, 0, 0, −1], and G=+2 holds according to equation (3). Thus, according to equation (3), the value of G, i.e., the determination information differs for each recorded code, such as G=−2 for the recorded code “101” (ternary value “2”), G=0 for the recorded code “011” (ternary value “0”), and G=+2 for the recorded code “011”. Thus, in the embodiment, the correspondence between the address reproduction signal and the recorded code (ternary value) is determined based on the determination information G obtained through equation (3).

Though here in the embodiment, the determination information G is found according to the inner product factor [0, 1, 1, 1, 1, 0], different weighting can be employed as far as a higher weighting is given to the sampled value in the middle of the cycle of the address reproduction signal. For example, 0.2*[0, 4, 6, 6, 4, 0] may be employed to obtain the determination information G. Further, though in the embodiment, the determination information G is found based on the inner product, the determination information G can be found according to the weighting averaging circuit that performs other process than the inner product calculating process.

The ternary gray code processing unit 406, when a gray code processing flag is ON, converts the received ternary gray code into a corresponding ternary value and sends the result to the ternary value reproducing unit since the ternary code obtained from the ternary code converter 405 is a ternary gray code. On the other hand, when the gray code processing flag is OFF, the ternary code supplied from the ternary code converter 405 is a ternary value without the conversion into the ternary gray code. Hence, the ternary gray code processing unit 406 supplies the received ternary value as it is to the ternary value reproducing unit 407. Here, the gray code processing flag is a flag to determine whether to perform the gray code inversion or not. When the gray code processing flag is ON as described above, the inversion from the ternary gray code to the ternary value is performed, whereas when the gray code processing flag is OFF, the inversion is not performed. The gray code processing flag is previously turned OFF when the magnetic head reads in the sector information which is not converted into the ternary gray code, whereas the gray code processing flag is previously turned ON when the magnetic head reads in the cylinder information which is converted into the ternary gray code.

The inversion of the ternary gray code of the cylinder information to the ternary value by the ternary gray code processing unit 406, i.e., the inversion of equation (1), can be represented by equation (4):
Tri(k)=mod(Tri(k+1)+Gray(k), 3) (4)
where k represents a number of digits of the recorded code corresponding to “1”, and equation (4) is equivalent to the inversion of equation (1). Though the value k is counted from a lower digit, in an actual address signal reproduction the processing is performed sequentially from an upper digit. Hence, the ternary gray code processing unit 406 performs the inversion of the ternary gray code according to equation (5) which is equivalent to the expression (4) and which employs a state counter n corresponding to an elapsed time since the start of the conversion:
Tri(n)=mod(Tri(n−1)+Gray(n), 3) (5)
where n represents a number of digits of the ternary gray code to be converted when counted from an upper digit.

The ternary value reproducing unit 407 performs a conversion of the ternary value supplied from the ternary gray code processing unit 406 to the binary value. A binary value Val(n) obtained as a result of conversion from the upper digit to the n-th digit of the ternary value can be represented by equation (6) with Val(n−1):
Val(n)=Val(n−1)*3+Tri(n) (6)
where Val(0)=0 and n=1 to N.

Thus, the converted binary value Val of the N-digit ternary value can be represented by equation (7):
Val=( . . . (((Tri(N)*3)+Tri(N−1))*3+Tri(N−2))*3+ . . . +Tri(1)) (7)

Here, a manner of conversion from the ternary value to the binary value is not limited by the manner employed in the embodiment, and any other known technique may be used.

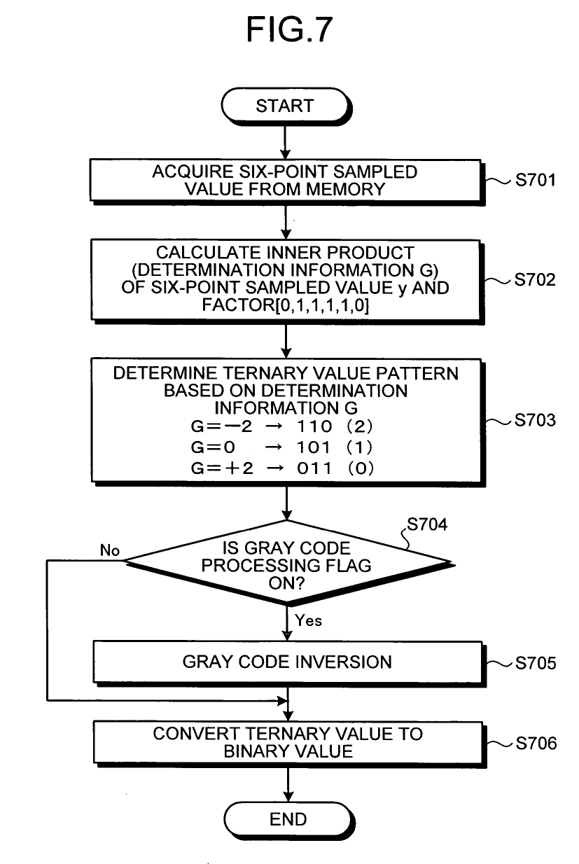

Next, reproduction from the address area by the address area reproducing circuit 400 according to the embodiment with the above-described structure will be described. FIG. 7 is a flowchart of a process sequence of the reproduction from the address area by the address area reproducing circuit 400.

When the magnetic head moves up to the address area 112 of the servo area 110 of a target track, the address signal reproduction starts. The analog reproduction signal read out from the address area 112 by the magnetic head is sent to the CTF 401. The CTF 401 performs filtering of the analog reproduction signal to obtain an equalization signal which is supplied as an input to the A-D converter 402. The A-D converter 402 performs sampling of the reproduction signal at a sampling timing corresponding to the synchronization clock determined in the processing of the reproduction signal from the preamble area, to output the sampled values from six points in one cycle to the FIR filter 403. The FIR filter 403 equalizes the sampled values of six points and stores the result in the memory 404.

The ternary code converter 405 acquires the six-point sampled values for one cycle of the address reproduction signal from the memory 404 (step S701). Then, the ternary code converter 405 calculates the inner product of the acquired six-point sampled value y and the inner product factor [0, 1, 1, 1, 1, 0] according to equation (3) to utilize the obtained inner product as determination information G (step S702).

Then, the ternary code converter 405 determines which of the recorded codes “110”, “101”, and “011” corresponds to the address reproduction signal according to the value of the determination information G and supplies the result to the ternary gray code processing unit 406. More specifically, the ternary code converter 405 determines that the recorded code is “110” (ternary value “2”) when the determination information G=−2, that the recorded code is “101” (ternary value “1”) when the determination information G=0, and that the recorded code is “011” when the determination information G=+2 (ternary value “0”) (step S703).

The ternary gray code processing unit 406 determines whether the gray code processing flag is ON or not (step S704). Then, when the ternary gray code processing unit 406 determines that the gray code processing flag is OFF (No in step S704), the information read out by the magnetic head is a ternary value, such as sector information, which is not converted into the ternary gray code. Hence, the ternary gray code processing unit 406 outputs the output from the ternary code converter 405 to the ternary value reproducing unit 407 without performing the inversion.

On the other hand, when the ternary gray code processing unit 406 determines that the ternary gray code processing flag is ON in step S704 (Yes in step S704), the information read out by the magnetic head is a ternary gray code such as the cylinder information. Hence the ternary gray code processing unit 406 performs the inversion to the ternary value according to equation (5) (step S705).

The process of the inversion will be described more in detail based on an example where the cylinder information “52001” (decimal), i.e., the ternary gray code corresponding to “02122022222” (ternary), is subjected to the inversion into the ternary value “02122022222” (ternary). When the given ternary gray code value is “02210120000” (ternary), the gray code value of each digit is supplied sequentially as an input to the ternary gray code processing unit 406 from the upper digit in the order of Gray(1)=0, Gray(2)=2, Gray(3)=2, . . . , Gray(11)=0.

When the gray code processing flag is OFF, the ternary gray code processing unit 406 resets the ternary value Tri calculated in the previous processing according to equation (5) to zero and stores the result. Hence, the ternary value Tri is zero immediately after the gray code processing flag is turned ON, and Tri(0) is set to zero.

Immediately after the gray code processing flag is turned ON, Gray(1)=0, and the ternary gray code processing unit 406 performs the operation according to equation (5), and outputs Tri(1)=mod(0, 3)=0. Thereafter the result of the previous operation, Tri(1) is updated to zero to be utilized for the conversion of the next digit. Similarly, the values are converted from the upper digit in the order of Tri(2)=mod(0+2, 3)=2, Tri(3)=mod(2+2, 3)=1, . . . , Tri(11)=mod(2+0, 3)=2, and thus the inversion to the value “02122022222” (ternary) is performed.

After the completion of the gray code inversion by the ternary gray code processing unit 406, the ternary value reproducing unit 407 converts the ternary value such as cylinder information after the gray code inversion by the ternary gray code processing unit 406, or the ternary value supplied as it is without the gray code inversion such as sector information, to the binary value according to equations (6) and (7) (step S706).

For example, in the above-described example, the value “02122022222” (ternary) obtained via the gray code inversion is converted into the value “1100101100100001” (binary) by the ternary value reproducing unit 407 according to equations (6) and (7), and reproduced as “52001” (decimal) in the decimal representation.

Thus, in the magnetic recording medium according to the embodiment, the ratios of the magnetic portions to the non-magnetic portions in the data area 100, the preamble area 111, and the address area 112 are substantially 2:1, and the rate of an area occupied by the magnetic portions is uniform over substantially entire surface of the magnetic recording medium. Hence, there is little variation in distribution of the ratio of unevenness of the stamper employed for the imprinting at the manufacture of the magnetic recording medium, and the imprinting of the magnetic pattern can be stably realized.

Further, when the data is reproduced from the servo area of the magnetic recording medium according to the embodiment, the magnetic record reproducing apparatus according to the embodiment finds the ternary value corresponding to the sampled value of the reproduction signal of the sector information reproduced from the address area 112, converts the obtained ternary value to the sector information represented by a binary value, finds the ternary value converted into the ternary gray code corresponding to the sampled value of the reproduction signal of the cylinder information reproduced from the address area 112, and converts the ternary value obtained via the inversion of the ternary gray code into the ternary value into the cylinder information represented by a binary value. Thus, the quality of the process of reproduction from the servo area can be maintained similarly to the quality realized in the address area recorded according to the conventional Manchester coding.

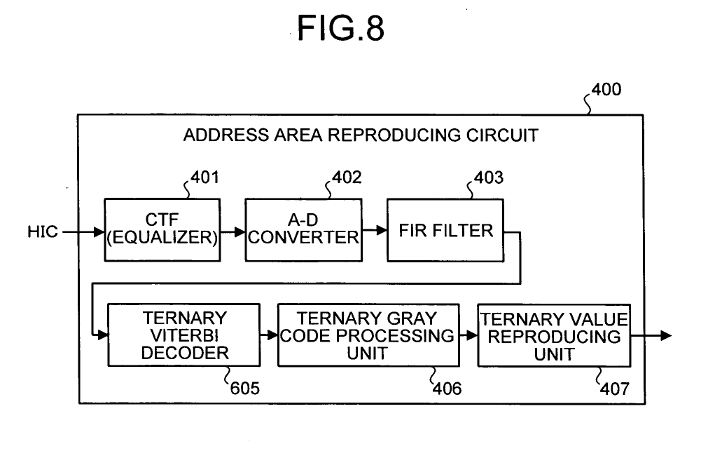

Here in the address area reproducing circuit of the magnetic record reproducing apparatus according to the embodiment, the memory 404 and the ternary code converter 405 cooperate to determine which of the recorded codes “110”, “101”, and “011” the address reproduction signal corresponds to. Alternatively, as shown in FIG. 8, the determination on such correspondence with the recorded code may be realized based on the maximum likelihood estimation by a ternary Viterbi decoder 605 instead of by the memory 404 and the ternary code converter 405.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A magnetic recording medium comprising:
a data area into which data can be written; and
a servo area having a preamble area that serves to realize clock synchronization and an address area in which address information of sectors and cylinders is recorded,
wherein a ratio of a magnetic portion to a non-magnetic portion in a total of the data area, the preamble area, and the address area is substantially 2:1.

2. The magnetic recording medium according to claim 1, wherein
in the address area, when the magnetic portion is represented as “1” and the non-magnetic portion is represented as “0”, a ratio of a portion where “1” is recorded to a portion where “0” is recorded is 2:1, and
the address information is recorded as a three-digit ternary value represented by “1” and “0”.

3. The magnetic recording medium according to claim 2, wherein
the address area has an area where the address information is recorded as a ternary gray code which is obtained as a result of conversion of the ternary value into a gray code.

4. The magnetic recording medium according to claim 3, wherein
in the address area, the address information of the cylinder called cylinder information is recorded as the ternary gray code.

5. The magnetic recording medium according to claim 4, wherein
in the address area, the cylinder information is recorded as the ternary gray code represented by
Gray(k)=mod(2*Tri(k+1)+Tri(k), 3)
where mod(m, n) is a residual function for finding a residue at division of m by n, Gray(k) is a value in the k-th digit of a ternary gray code, and Tri(k) is a value in the k-th digit of a cylinder address represented by an 11-digit ternary gray code.

6. The magnetic recording medium according to claim 4, wherein
in the address area, the address information of the sector called sector information is recorded as a ternary value which is not converted into the ternary gray code.

7. A magnetic record reproducing apparatus comprising:
an address area reproducing unit which reproduces data from an address area of a magnetic recording medium, the magnetic recording medium including a data area to which data can be written into and a servo area where information for positioning a magnetic head at a target position is recorded, the servo area having a preamble area that serves to realize clock synchronization and the address area in which address information of sectors and cylinders is recorded, the address information being recorded as a three-digit ternary value represented by “1” and “0”, wherein when a magnetic portion and a non-magnetic portion are represented as “1” and “0”, respectively, a ratio of a portion where “1” is recorded to a portion where “0” is recorded is 2:1,
wherein the address area reproducing unit includes
a ternary code converter that finds the three-digit ternary value corresponding to a sampled value from one cycle of an address reproduction signal reproduced from the address area, the sampled value being sampled with a synchronization clock determined according to a reproduction signal processing for the preamble area; and
a ternary value reproducing unit that converts the ternary value obtained by the ternary code converter into the address information represented by a binary value.

8. The magnetic record reproducing apparatus according to claim 7, wherein
the ternary code converter calculates an inner product of a sampled value obtained from one cycle of the address reproduction signal and a weighting factor that gives a higher weight to a sampled value obtained from a middle of one cycle of the address reproduction signal than to a sampled value obtained from a periphery of one cycle of the address reproduction signal, and finds the three-digit ternary value corresponding to the sampled value based on the inner product.

9. The magnetic record reproduction apparatus according to claim 6, further comprising
a ternary gray code processing unit that performs an inversion of the ternary value of the ternary gray code obtained by the ternary code converter into a ternary value that is not subjected to conversion into the gray code when the address information is a ternary gray code obtained by converting the ternary value into the gray code,
wherein the ternary value reproducing unit converts the ternary value obtained via the inversion by the ternary gray code processing unit into address information represented by a binary value.

10. The magnetic record reproducing apparatus according to claim 9, wherein
the ternary gray code processing unit performs an inversion of the ternary value of the ternary gray code obtained by the ternary code converter of the cylinder information which is the address information of the cylinder into the ternary value which is not subjected to the conversion into the gray code, and supplies the result as an output to the ternary value reproducing unit.

11. The magnetic record reproducing apparatus according to claim 10, wherein
the ternary gray code processing unit performs the inversion of the ternary value of the ternary gray code obtained by the ternary code converter into the ternary value which is not subjected to the conversion into the gray code according to
Tri(n)=mod(Tri(n−1)+Gray(n, 3))
where mod(a, b) is a residual function for finding a residue at a division of a by b, Gray(n) is a value in the n-th digit of the ternary gray code, and Tri(n) is a value in the n-th digit of the cylinder address represented by an 11-digit ternary value.

12. The magnetic record reproducing apparatus according to claim 10, wherein
the ternary gray code processing unit further supplies as an output to the ternary value reproducing unit the ternary value of the sector information that is the address information of the sector, obtained by the ternary code converter.

13. A method of reproducing data comprising
reproducing data from an address area of a magnetic recording medium, the magnetic recording medium including a data area to which data can be written into and a servo area where information for positioning a magnetic head at a target position is recorded, the servo area having a preamble area that serves to realize clock synchronization and the address area in which address information of sectors and cylinders is recorded, the address information being recorded as a three-digit ternary value represented by “1” and “0”, wherein when a magnetic portion and a non-magnetic portion are represented as “1” and “0”, respectively, a ratio of a portion where “1” is recorded to a portion where “0” is recorded is 2:1,
wherein the reproducing includes
finding the three-digit ternary value corresponding to a sampled value from one cycle of an address reproduction signal reproduced from the address area, the sampled value being sampled with a synchronization clock determined according to a reproduction signal processing for the preamble area; and
converting the ternary value found into the address information represented by a binary value.
